(19) United States
(12) Patent Application Publication
(10) Pub. No.: US 2018/0361186 A1
(43) Pub. Date: Dec. 20, 2018

(54) Fire-Extinguishing Composition

(71) Applicant: Xi'an Westpeace Fire Technology Co., Ltd, Xi'an Shaanxi (CN)

(72) Inventors: Gaofeng Zheng, Xi'an Shaanxi (CN); Chao Gao, Xi'an Shaanxi (CN); Junjun Shi, Xi'an Shaanxi (CN); Zhanjun Yang, Xi'an Shaanxi (CN)

(21) Appl. No.: 15/780,633

(22) PCT Filed: Nov. 30, 2016
(86) PCT No.: PCT/CN2016/107856

§ 371 Date: May 31, 2018

(30) Foreign Application Priority Data
Dec. 1, 2015 (CN) 201510867612.5

(51) Int. Cl. A62D 1/06; A62D 1/00

(52) U.S. Cl. CPC A62D 1/06; A62D 1/005

(57) ABSTRACT

The present invention discloses a fire-extinguishing composition consisting of substances having the following mass percentages: an aromatic organic acid compound, 20% to 90%; an alcohol-based compound, 10% to 80%; the fire-extinguishing composition produces a great quantity of substances available for fire extinguishing by utilizing the high temperature from combustion of a pyrotechnic agent. The aromatic organic acid compound and the alcohol-based compound of the present invention may undergo sublimation by endothermic process, decomposition and reaction between each other at the high temperature, releasing a great quantity of fire-extinguishing substances to carry out the fire extinguishing; the fire-extinguishing composition of the present invention compensates for the loss in the performance of an aerosol generating agent caused by a general cooling layer, and also enhances the fire-extinguishing performance of the entire fire-extinguishing product, while reducing the temperature at a nozzle of the product; the sediment of the present fire-extinguishing composition has low hygroscopicity and high insulation resistance, which is suitable for electric places without causing corrosion of and other adverse effects on the electrical equipment.

### FIELD OF THE INVENTION

The present invention pertains to the technical field of aerosol fire extinguishing, particularly to a thermal aerosol fire-extinguishing composition.

### BACKGROUND OF THE INVENTION

Since the specific target of each country for substitution of Halon fire-extinguishing agents was put forth in Canadian Montreal Convention in 1987, all countries in the world have been committed to the research of new fire-extinguishing techniques. Fire-extinguishing techniques with high fire-extinguishing efficiency and no environmental pollution are directions of our effort.

A gas fire-extinguishing system, a powder extinguishing system, a water fire-extinguishing system and the like are harmless to environment, so they are selected as substitutes of Halon fire-extinguishing agents and are widely used. The fire-extinguishing mechanism of the fire-extinguishing systems of carbon dioxide, IG541 and inert gases mainly relies on physical fire-extinguishing. The fire is put out by lowering the concentration of oxygen in the firing area. This fire-extinguishing method would easily threaten human safety. The powder extinguishing system puts out a fire by spraying powder under the action of pressurized gas to contact flame and realize physical and chemical suppression effect. A water mist fire-extinguishing system achieves the objects of controlling, suppressing and putting out a fire through triple actions of cooling, smothering, and isolation of thermal radiation by using water mist.

However, all these fire-extinguishing systems need high pressure storage. Not only the volume is large but also there is a risk of physical explosion during storage. A document “Safety Analysis of Gas Fire-extinguishing System” (Fire Science and Technology 2002 21(5)) analyzes the risk of a gas fire-extinguishing system and enumerates the safety accidents triggered by the stored pressure gas fire-extinguishing system during use.

The existing thermal aerosol fire-extinguishing agents are mainly type S and type K fire-extinguishing agents. The comprehensive analysis of their performance and features indicates that their fire-extinguishing mechanism is that the thermal aerosol fire-extinguishing agents take a redox reaction through agent combustion to release a great quantity of gas and active particles and the goal of integrated chemical and physical fire-extinguishing is realized through the chain scission reaction of the active particles and covering and smothering of a great quantity of gas. The disadvantage of the thermal aerosol fire-extinguishing agents is that the thermal aerosol fire-extinguishing agent will release a great quantity of heat while it takes the combustion reaction to release the thermal aerosol, which may cause a secondary combustion. In order to effectively reduce the temperature of the device and aerosol and avoid the secondary fire, a cooling system needs to be added. The cooling materials of the existing thermal aerosol fire-extinguishing units can reduce the temperature of products, but they also greatly weaken the fire-extinguishing performance of the products. In order to compensate the loss in the fire-extinguishing performance caused by the cooling system, many products either lower the fire-extinguishing level or continuously increase the mass of the actual fire-extinguishing agent, rendering the increase of product volume and the decrease of use efficiency, which results in a complex and cumbersome structure of the device, such as the S type fire-extinguishing agent. The traditional K type fire-extinguishing agent, however, has high fire extinguishing efficiency and small volume, but the sediment thereof is corrosive and would bring secondary damage.

Therefore, there is an urgent need in the market for a fire-extinguishing composition which not only ensures the fire extinguishing efficiency of the K type fire-extinguishing agent, makes the fire-extinguishing equipment small in size, light in weight and easy to be installed, but also ensures that the fire-extinguishing particles released would not produce secondary damage to the places where the fire extinguishing is carried out, in particular some places having electrical equipment, and has good corrosion resistance.

### SUMMARY OF THE INVENTION

With respect to the defects of the prior art, the object of the present invention is to provide a fire-extinguishing composition that has high fire extinguishing efficiency, good corrosion resistance, and tends not to bring secondary damage.

The technical scheme of the present invention is:

A fire-extinguishing composition, wherein the fire-extinguishing composition consists of substances having the following mass percentages:

an aromatic organic acid compound 20%-90%

an alcohol-based compound 10%-80%

the fire-extinguishing composition produces a great quantity of substances available for fire extinguishing by utilizing the high temperature from combustion of a pyrotechnic agent.

Further, the aromatic organic acid compound is a monobasic aromatic organic acid compound and/or a dibasic aromatic organic acid compound.

Further, the monobasic aromatic organic acid compound comprises: one or more of 2,5-dimethylbenzoic acid, 2,4-dihydroxybenzoic acid, m-hydroxybenzoic acid, 3-hydroxyphenylacetic acid, 2,4-dimethoxybenzoic acid, m-methylbenzoic acid, 2-amino-3-methylbenzoic acid, 2,3-dihydroxybenzoic acid, 4-methyl salicylic acid, 2-pyrazinecarboxylic acid, 3-hydroxy-4-methoxybenzoic acid, 3-hydroxy-4-methylbenzoic acid, 4-phenylbenzoic acid, p-tert-butylbenzoic acid, 4-isopropylbenzoic acid, 4′-hydroxybiphenyl-4-carboxylic acid, 3-amino-4-methylbenzoic acid, 2,4,6-trimethylbenzoic acid, 3,4,5-trimethoxybenzoic acid, 2,6-dimethoxybenzoic acid, 4-(hydroxymethyl)phenoxyacetic acid, 2,6-dimethylbenzoic acid, 3,4-dimethoxybenzoic acid, 2,2-diphenylacetic acid, 5-methoxysalicylic acid, 3,4-dimethylbenzoic acid, o-benzoylbenzoic acid, 3-phenylbenzoic acid, 2,5-dimethylphenylacetic acid, 5-methyl salicylic acid, 2,6-dihydroxybenzoic acid, 2-hydroxy-6-naphthoic acid, p-methylbenzoic acid, p-methoxybenzoic acid, 2,3-dimethoxybenzoic acid, 3-phenyl-2-propenoic acid, 3-benzoylbenzoic acid, coumaric acid, and 2,4,6-trihydroxybenzoic acid.

Further, the dibasic aromatic organic acid compound comprises: one or more of 5-hydroxyisophthalic acid, biphenyl-4,4′-dicarboxylic acid, isophthalic acid, phthalic acid, terephthalic acid, p-benzenediacetic acid, 1,2-cyclohexanedicarboxylic acid, 1,2-benzenediacetic acid, 1,4-naphthalenedicarboxylic acid, 2,2′-biphenyldicarboxylic acid, 2,7-naphthalenedicarboxylic acid, 5-methoxyisophthalic acid, and 1,3-benzenediacetic acid.

Further, the alcohol-based compound comprises: one or more of p-hydroxybenzyl alcohol, erythritol, lactitol, triphenylmethanol, 3-hydroxy-4-methoxybenzyl alcohol, sorbitol, tebuconazole, 2-hydroxy-5-methyl-1,3-benzenedimethanol, maltitol, pentaerythritol, dipentaerythritol, tripentaerythritol, diethylene glycol dodecyl ether, tricyclo[3.3.1.1(3,7)]decan-2-ol, mannitol, and glucitol.

Further, the mass percentages of various components in the fire-extinguishing composition are preferably:

the aromatic organic acid compound 40%-90%

the alcohol-based compound 10%-60%.

Further, the fire-extinguishing composition also contains an additive which has a mass percentage of greater than 0 to less than or equal to 5%.

Further, the additive is one or more of stearate, graphite, sodium silicate, phenolic resin, shellac, starch, dextrin, rubber, epoxy resin, acetal adhesive, hydroxypropyl methylcellulose, and ethyl cellulose.

Further, the components and their mass percentages in the fire-extinguishing composition are preferably:

the aromatic organic acid compound 30%-80%

the alcohol-based compound 15%-65%

the additive 0.2%-5%.

Further, the components and their mass percentages in the fire-extinguishing composition are preferably:

the aromatic organic acid compound 40%-80%

the alcohol-based compound 15%-55%

the additive 0.2%-5%.

The flame suppression mechanism of the fire-extinguishing composition of the present invention is as follows:

When used, the pyrotechnic agent is used as a source of heat and a source of power, and with the heat released from ignition and combustion of the pyrotechnic agent, the fire-extinguishing composition is further decomposed at a high temperature to release fire-extinguishing substances, which may react with one or more of O., OH., H. free radicals necessary for the chain combustion reaction via free radicals, thereby cutting off the chain combustion reaction. It is also possible to reduce the oxygen partial pressure by physical action to suppress the flame, or that physical and chemical inhibitions may take place simultaneously to achieve fire extinguishing. Meanwhile, they take a synergistic interaction effect with the pyrotechnic agent to further raise the fire extinguishing efficiency of the fire-extinguishing agent and greatly shorten the effective fire extinguishing time.

As compared with the existing thermal aerosol fire extinguishing agents, the fire-extinguishing composition of the present invention has the following advantages:

1. The aromatic organic acid compound and the alcohol-based compound in the fire-extinguishing composition of the present invention may undergo sublimation by endothermic process, decomposition, and reaction between each other at a high temperature to generate a large number of nanometer-level effective fire-extinguishing particles and a plurality of free radicals, cutting off the combustion reaction chain; and function in fire extinguishing along with the reaction products of the thermal aerosol generating agent, which further improves the fire extinguishing efficiency of the fire extinguishing agent and shortens the effective fire extinguishing time.

2. The fire-extinguishing composition of the present invention compensates for the loss in the performance of the aerosol generating agent caused by a general cooling layer, and also enhances the fire-extinguishing performance of the entire fire-extinguishing product, while reducing the temperature at a nozzle of the fire-extinguishing device. Therefore, the fire-extinguishing composition is safer, would not do harm to fire fighters and also avoids secondary fires.

3. The sediment from the fire-extinguishing composition of the present invention after being sprayed has low hygroscopicity and high insulation resistance, which is suitable for electric places without causing corrosion of and other adverse effects on the electrical equipment to avoid secondary damage to the electrical equipment.

4. An aerosol fire extinguishing device adopting the fire-extinguishing composition of the present invention does not need a cooling system with a complex structure and a large volume, so it has the characteristics of a handy structure, a simple technological process and good economy.

### DETAILED DESCRIPTION OF THE EMBODIMENTS

Below are embodiments of the present invention for illustrating a technical scheme for solving the technical problems in this application document and helping those skilled in the art understand the content of the present invention, however, the realization of the technical scheme of the present invention is not limited to these embodiments.

### Example 1

Fire-extinguishing composition formulation: m-hydroxybenzoic acid 30%, lactitol 70%

When used, 60 g of the above-described fire-extinguishing agent was weighed and assembled together with 50 g of the aerosol generating agent for use, and the fire extinguishing effect is shown in Table 1.

### Example 2

Fire-extinguishing composition formulation: 2,5-dimethylbenzoic acid 20%, 4-methyl salicylic acid 15%, mannitol 64.8%, sodium silicate 0.2%

When used, 60 g of the above-described fire-extinguishing agent was weighed and assembled together with 50 g of the aerosol generating agent for use, and the fire extinguishing effect is shown in Table 1.

### Example 3

Fire-extinguishing composition formulation: phthalic acid 35%, mannitol 55%, maltitol 9%, phenolic resin 1%

When used, 60 g of the above-described fire-extinguishing agent was weighed and assembled together with 50 g of the aerosol generating agent for use, and the fire extinguishing effect is shown in Table 1.

### Example 4

Fire-extinguishing composition formulation: 5-methoxysalicylic acid 10%, isophthalic acid 10%, terephthalic acid 20%, maltitol 28%, pentaerythritol 30%, starch 2%

When used, 60 g of the above-described fire-extinguishing agent was weighed and assembled together with 50 g of the aerosol generating agent for use, and the fire extinguishing effect is shown in Table 1.

### Example 5

Fire-extinguishing composition formulation: 3-phenyl-2-propenoic acid 50%, pentaerythritol 47%, epoxy resin 3%

When used, 60 g of the above-described fire-extinguishing agent was weighed and assembled together with 50 g of the aerosol generating agent for use, and the fire extinguishing effect is shown in Table 1.

### Example 6

Fire-extinguishing composition formulation: phthalic acid 76%, dipentaerythritol 10%, mannitol 10%, hydroxypropyl methylcellulose 4%

When used, 60 g of the above-described fire-extinguishing agent was weighed and assembled together with 50 g of the aerosol generating agent for use, and the fire extinguishing effect is shown in Table 1.

### Example 7

Fire-extinguishing composition formulation: terephthalic acid 89%, dipentaerythritol 10%, ethyl cellulose 1%

When used, 60 g of the above-described fire-extinguishing agent was weighed and assembled together with 50 g of the aerosol generating agent for use, and the fire extinguishing effect is shown in Table 1.

The various components of each of Examples 1-7 were taken in a certain proportion, using water or alcohol as a solvent, pelletized by using a 20-mesh sieve before air-drying, a mold release agent was added, and after mixing the same, the mixture was sieved by a 15-mesh sieve, and molded into a shape of ball, slice, strip, block or honeycomb through pelleting, mould pressing, extruding or other processes; 60 g of the mixture was added to a fire-extinguishing device filled with 50 g of a type K aerosol generating agent, and a fire extinguishing experiment was performed according to a fire extinguishing experiment model.

This fire extinguishing experiment set 4 control groups:

Comparative Example 1: 60 g of an alcohol-based compound

Comparative Example 2: 60 g of an aromatic organic acid compound

Comparative Example 3: 60 g of a type K aerosol generating agent

Comparative Example 4: 60 g of a type S aerosol generating agent

The samples of Comparative Examples 1-4 were put into a fire-extinguishing device and a fire extinguishing experiment was performed according to a fire extinguishing experiment model. The fire extinguishing experiment and the test method for the insulation resistance of the sediment were carried out by referring to the relevant method in GA499.1-2010 “Aerosol Fire Extinguishing System Section 1: Thermal Aerosol Fire-Extinguishing Device”. The space for the fire extinguishment was a 2 cubic-meter test box, with 5 fire pots set inside, and the number of fire extinguishments was an average number in three tests. The number of fire extinguishments, the temperature at the nozzle and the insulation resistance of the sediment were recorded, respectively.

The experimental results are shown in Table 1:

TABLE 1
Comparison of various compositions and experimental results

| | Composition of the Example (mass percentage) | | | | | | | | | | |
|---|---|---|---|---|---|---|---|---|---|---|---|
| | NO. | NO. | NO. | NO. | NO. | NO. | NO. | Comparative | Comparative | Comparative | Comparative |
| Component | 1 | 2 | 3 | 4 | 5 | 6 | 7 | example 1 | example 2 | example 3 | example 4 |
| m-Hydroxybenzoic acid | 30 | | | | | | | | | | |
| 2,5-Dimethylbenzoic acid | | 20 | | | | | | | | | |
| 4-Methyl salicylic acid | | 15 | | | | | | | | | |
| Phthalic acid | | | 35 | | | 76 | | | 99.8 | | |
| 5-Methoxysalicylic acid | | | | 10 | | | | | | | |
| Isophthalic acid | | | | 10 | | | | | | | |
| Terephthalic acid | | | | 20 | | | 89 | | | | |
| 3-Phenyl-2-propenoic acid | | | | | 50 | | | | | | |
| lactitol | 70 | | | | | | | | | | |
| mannitol | | 64.8 | 55 | | | 10 | | 99.8 | | | |
| maltitol | | | 9 | 28 | | | | | | | |
| pentaerythritol | | | | 30 | 47 | | | | | | |
| Dipentaerythritol | | | | | | 10 | 10 | | | | |
| sodium silicate | | 0.2 | | | | | | | | | |
| phenolic resin | | | 1 | | | | | | | | |
| starch | | | | 2 | | | | | | | |
| epoxy resin | | | | | 3 | | | | | | |
| Hydroxypropy 1 methyl | | | | | | 4 | | 0.2 | 0.2 | | |
| cellulose | | | | | | | | | | | |
| ethyl cellulose | | | | | | | 1 | | | | |
| type K fire-extinguishing | | | | | | | | | | ✓ | |
| agent | | | | | | | | | | | |
| type S fire-extinguishing | | | | | | | | | | | ✓ |
| agent | | | | | | | | | | | |

Comparison in experimental results

| | | | | | | | | | | | |
|---|---|---|---|---|---|---|---|---|---|---|---|
| Number of fire | 4.3 | 4 | 4 | 4.7 | 4.3 | 4.3 | 4 | 4.7 | 4.3 | 4.7 | 2 |
| extinguishments | | | | | | | | | | | |
| Insulation resistance | 24 | 25 | 22 | 20 | 29 | 19 | 22 | 0.21 | 0.37 | 0.08 | 21 |
| of the sediment MΩ | | | | | | | | | | | |
| Temperature at the | 431 | 529 | 496 | 417 | 534 | 488 | 405 | 508 | 472 | 1417 | 1342 |
| nozzle ° C. | | | | | | | | | | | |
| Flaming at the nozzle | No | No | No | No | No | No | No | No | No | Yes | Yes |

The foregoing embodiments are merely explanations to the preferred schemes of the present invention, and are not the limitation to the present invention. All changes and modifications to the foregoing embodiments within the essential spirit scope of the present invention should fall within the scope of protection of the claims of the present application.

1. A fire-extinguishing composition, wherein the fire-extinguishing composition consists of substances having the following mass percentages:
an aromatic organic acid compound 20%-90%
an alcohol-based compound 10%-80%
the fire-extinguishing composition produces a great quantity of substances available for fire extinguishing by utilizing the high temperature from combustion of a pyrotechnic agent.

2. The fire-extinguishing composition according to claim 1, wherein the aromatic organic acid compound is a monobasic aromatic organic acid compound and/or a dibasic aromatic organic acid compound.

3. The fire-extinguishing composition according to claim 2, wherein the monobasic aromatic organic acid compound comprises: one or more of 2,5-dimethylbenzoic acid, 2,4-dihydroxybenzoic acid, m-hydroxybenzoic acid, 3-hydroxyphenylacetic acid, 2,4-dimethoxybenzoic acid, m-methylbenzoic acid, 2-amino-3-methylbenzoic acid, 2,3-dihydroxybenzoic acid, 4-methyl salicylic acid, 2-pyrazinecarboxylic acid, 3-hydroxy-4-methoxybenzoic acid, 3-hydroxy-4-methylbenzoic acid, 4-phenylbenzoic acid, p-tert-butylbenzoic acid, 4-isopropylbenzoic acid, 4′-hydroxybiphenyl-4-carboxylic acid, 3-amino-4-methylbenzoic acid, 2,4,6-trimethylbenzoic acid, 3,4,5-trimethoxybenzoic acid, 2,6-dimethoxybenzoic acid, 4-(hydroxymethyl)phenoxyacetic acid, 2,6-dimethylbenzoic acid, 3,4-dimethoxybenzoic acid, 2,2-diphenylacetic acid, 5-methoxysalicylic acid, 3,4-dimethylbenzoic acid, o-benzoylbenzoic acid, 3-phenylbenzoic acid, 2,5-dimethylphenylacetic acid, 5-methyl salicylic acid, 2,6-dihydroxybenzoic acid, 2-hydroxy-6-naphthoic acid, p-methylbenzoic acid, p-methoxybenzoic acid, 2,3-dimethoxybenzoic acid, 3-phenyl-2-propenoic acid, 3-benzoylbenzoic acid, coumaric acid, and 2,4,6-trihydroxybenzoic acid.

4. The fire-extinguishing composition according to claim 2, wherein the dibasic aromatic organic acid compound comprises: one or more of 5-hydroxyisophthalic acid, biphenyl-4,4′-dicarboxylic acid, isophthalic acid, phthalic acid, terephthalic acid, p-benzenediacetic acid, 1,2-cyclohexanedicarboxylic acid, 1,2-benzenediacetic acid, 1,4-naphthalenedicarboxylic acid, 2,2′-biphenyldicarboxylic acid, 2,7-naphthalenedicarboxylic acid, 5-methoxyisophthalic acid, and 1,3-benzenediacetic acid.

5. The fire-extinguishing composition according to claim 1, wherein the alcohol-based compound comprises: one or more of p-hydroxybenzyl alcohol, erythritol, lactitol, triphenylmethanol, 3-hydroxy-4-methoxybenzyl alcohol, sorbitol, tebuconazole, 2-hydroxy-5-methyl-1,3-benzenedimethanol, maltitol, pentaerythritol, dipentaerythritol, tripentaerythritol, diethylene glycol dodecyl ether, tricyclo[3.3.1.1(3,7)]decan-2-ol, mannitol, and glucitol.

6. The fire-extinguishing composition according to claim 1, wherein the mass percentages of various components in the fire-extinguishing composition are:
the aromatic organic acid compound 40%-90%
the alcohol-based compound 10%-60%.

7. The fire-extinguishing composition according to claim 1, wherein the fire-extinguishing composition further contains an additive which has a mass percentage of greater than 0 to less than or equal to 5%.

8. The fire-extinguishing composition according to claim 7, wherein the additive is one or more of stearate, graphite, sodium silicate, phenolic resin, shellac, starch, dextrin, rubber, epoxy resin, acetal adhesive, hydroxypropyl methylcellulose, and ethyl cellulose.

9. The fire-extinguishing composition according to claim 8, wherein the components and their mass percentages in the fire-extinguishing composition are:
the aromatic organic acid compound 30%-80%
the alcohol-based compound 15%-65%
the additive 0.2%-5%.
